(19) United States
(12) Patent Application Publication
(10) Pub. No.: US 2023/0181290 A1
(43) Pub. Date: Jun. 15, 2023

(54) SELF-LIGATING CROSSED BUCCAL TUBES

(71) Applicants: Peking University School of Stomatology, Beijing (CN); Center of Huanzhengduowei Education & Science and Technology, Beijing, Beijing (CN)

(72) Inventors: Tianmin XU, Beijing (CN); Kaiyuan XU, Beijing (CN)

(21) Appl. No.: 18/078,442

(22) Filed: Dec. 9, 2022

(30) Foreign Application Priority Data
Dec. 9, 2021 (CN) 202111499599.4
Dec. 9, 2021 (CN) 202123081606.7

(51) Int. Cl. A61C 7/28; A61C 7/14

(52) U.S. Cl. CPC A61C 7/282; A61C 7/143

(57) ABSTRACT

Disclosed is a self-ligating crossed buccal tube comprising a bracket body frame structure and a cover plate detachably installed on the bracket body frame structure, which includes four wings, and a first tube cavity for accommodating an archwire is formed by the four wings. Limiting structures are arranged below the first and fourth wings and on a side wall of a first groove. The first tube cavity used for accommodating a thick round wire or square archwire is formed through the four wings. The three limiting structures form two limiting channels used for accommodating a thin round wire. The limiting structures are used for providing a backward tilting moment for teeth, and the problem that the archwire cannot be inserted into the buccal tube after the distal end of the archwire is bent is solved by the sliding cover plate design.

### CROSS-REFERENCE TO RELATED APPLICATION(S)

This present application claims the benefit and priority of Chinese Patent Application No. 202123081606.7, filed Dec. 9, 2021 and Chinese Patent Application No. 202111499599.4, filed Dec. 9, 2021, the disclosures of which are hereby incorporated by reference in their entireties.

### TECHNICAL FIELD

The present invention relates to the technical field of orthodontic equipment, and in particular to a self-ligating crossed buccal tube.

### BACKGROUND ART

At present, in terms of structures, there are three kinds of buccal tubes in the domestic and foreign markets: the most traditional solid cavity type, double-winged wide bracket ligature type, and self-ligating bracket type; from the perspective of cavity presetting, most of them are buccal tubes preseted with normal tooth angles; for the XBT crossed buccal tube, which is designed for the first time on the basis of the main tube with a thin round tube to prevent the anterior inclination of the molar, and belongs to the solid cavity type, wherein an archwire can only be inserted into the cavity from the mesial direction, and if it is necessary to bend the archwire behind the main anchorage molar (usually tooth #6) (for example, the correction of bending of the uneven tooth #7), it is difficult for the archwire to pass through the buccal tube of the main anchorage molar; in order to overcome this problem, a structure similar to a wide double-winged bracket emerged for the common single-tube buccal tube of the main anchorage molar, so that the orthodontic archwire can enter the canal cavity from the buccal side and be fixed in the buccal tube cavity by a ligature wire or ligature ring; after the self-ligating brackets came out, the ligature-type common buccal tube was transformed into a self-ligating buccal tube with the same design, but both were of single-cavity structure, and could only be bent manually on stainless steel archwires if a tip-back moment was required. After the memory alloy nickel-titanium archwire, which can provide continuous light force, entered the orthodontic industry, the archwire bending became less easy because of the morphological memory characteristics of the archwire, so the design of XBT crossed buccal tube emerged to replace the traditional anchorage bending by the angle of the buccal tube. However, because there is a crossed tube cavity of two entities, the occlusogingival diameter is significantly larger than that of the traditional buccal tube with a single groove, making it difficult to adopt the existing self-ligating design, and there is neither a ligated type nor a self-ligating crossed buccal tube on the market.

### SUMMARY OF THE INVENTION

The present invention provides a self-ligating crossed buccal tube to solve the defects in the prior art that the crossed buccal tube has a large occlusogingival diameter and the archwire cannot be inserted into the solid type crossed buccal tube when the teeth behind the main anchorage molars require archwire bending, by constructing a limiting structure under the wing, thus forming at least two channels for the archwire to pass through, which makes the occlusogingival diameter of the buccal tube smaller on the one hand, and on the other hand can meet the needs of different orthodontic stages for different types of archwires and different anchorage bending angles.

The present invention provides a self-ligating crossed buccal tube, including: a bracket body frame structure and a cover plate, the cover plate being detachably installed on the bracket body frame structure; wherein,

the bracket body frame structure includes a first wing, a second wing, a third wing and a fourth wing, a first groove is formed by the first wing and the second wing, a second groove is formed by the third wing and the fourth wing, and a first tube cavity used for accommodating an archwire is formed by axially setting the first groove and the second groove;

a first limiting structure is arranged below the first wing and a second limiting structure is arranged below the fourth wing, and a second channel used for limiting the archwire with tip-back moment is formed by the first limiting structure and the second limiting structure;

a third limiting structure is arranged in a side wall of the first groove adjacent to the second wing, a third channel used for limiting the archwire with tip-back moment is formed by the third limiting structure and the second limiting structure.

The self-ligating crossed buccal tube according to the present invention, wherein the first limiting structure is a first circular groove structure located on an outer sidewall below the first wing.

The self-ligating crossed buccal tube according to the present invention, wherein the second limiting structure is a second circular groove structure located on the outer sidewall below the fourth wing.

The self-ligating crossed buccal tube according to the present invention, wherein the third limiting structure is a third circular groove structure opened on an inner sidewall of the first groove adjacent to the second wing.

The self-ligating crossed buccal tube according to the present invention, wherein the fourth wing has a width greater than or equal to the width of the third wing, and the first wing has a width greater than or equal to the width of the second wing.

The self-ligating crossed buccal tube according to the present invention, wherein a connecting line between the first limiting structure and the second limiting structure is at an included angle of −30° to −60° in a mesiodistal direction, a connecting line between the second limiting structure and the third limiting structure is at an included angle of −20° to −30° in a mesiodistal direction, and a connecting line between the first groove and the second groove is at an included angle of −2° to −10° in a mesiodistal direction.

The self-ligating crossed buccal tube according to the present invention, wherein a connecting line between the first limiting structure and the second limiting structure is at an included angle of −5° to −20° in a buccolingual direction, a connecting line between the second limiting structure and the third limiting structure is at an included angle of 0° to −15° in the buccolingual direction, and a connecting line between the first groove and the second groove is at an included angle of 0° to −10° in the buccolingual direction.

The self-ligating crossed buccal tube according to the present invention, wherein the cover plate has an outer profile of parallelogram and a step-type structure is provided on the cover plate, a track is provided on the bracket body frame structure adapted to the step-type structure, and the cover plate is slidably arranged on the bracket body frame structure by the cooperation of the step-type structure and the track.

The self-ligating crossed buccal tube according to the present invention, further including a limiting device, the limiting device being provided on the second wing and the fourth wing, respectively, the cover plate is provided with a recess adapted to the limiting device, and the limiting device being able to snap to the recess accordingly.

The present invention provides a self-ligating crossed buccal tube, on the basis that the occlusogingival diameter of the traditional ligature type buccal tube is not increased, the first tube cavity used for accommodating a thick round wire or square archwire is formed through the four wings, and limiting structures are constructed below the wings, and three limiting structures are utilized to form two limiting channels used for accommodating a thin round wire, the requirements on different angles of the archwire in different orthodontic treatment stages are met; the limiting structures are used for providing a tip-back moment for molars, and the problem that the archwire cannot be inserted into the buccal tube after the distal end of the archwire being bent is solved by the sliding cover plate design.

### BRIEF DESCRIPTION OF THE DRAWINGS

In order to more clearly illustrate the technical solutions in the present invention or prior art, the following is a brief description of the accompanying drawings that need to be used in the description of the examples or prior art. It is obvious that the accompanying drawings in the following description are some examples of the present invention, and other accompanying drawings can be obtained according to these accompanying drawings without creative work for a person skilled in the art.

FIG. 1 is a schematic diagram of the structure of the buccal tube provided by the present invention;

FIG. 2 is a schematic diagram of the structure of the bracket body frame structure mating with the archwire when the first tube cavity is used in the present invention;

FIG. 3 is a schematic diagram of the structure of the bracket body frame structure mating with the archwire when the second channel is used in the present invention;

FIG. 4 is a schematic diagram of the structure of the bracket body frame structure mating with the archwire when the third channel is used in the present invention;

FIG. 5 is a schematic diagram of one of the structures of the buccal tube provided by the present invention along the direction of inserting the cover plate into the bracket frame structure;

FIG. 6 is a schematic diagram of the structure of another cover plate design mode of the buccal tube provided by the present invention; and

### REFERENCE NUMERALS

1: cover plate; 21: first wing; 22: second wing
23: third wing; 24: fourth wing; 25: second circular groove structure;
26: first circular groove structure; 27: first groove; 28: second groove;
29: third circular groove structure;
3: archwire; 4: track; 5: limiting device
6: step-type structure; 7: recess; 8: base plate.

### Specific Modes for Carrying Out the Embodiments

In order to make the purpose, technical solutions and advantages of the present invention clearer, the technical solutions in the present invention will be described clearly and completely below in conjunction with the accompanying drawings in the present invention, and it is clear that the described examples are a part of the examples of the present invention, and not all of them. Based on the examples in the present invention, all other examples obtained by a person skilled in the art without making creative labor fall within the scope of protection of the present invention.

A buccal tube of the present invention is described below in connection with FIGS. 1 to 6. The buccal tube includes: a bracket body frame structure and a cover plate 1, the cover plate is detachably installed on the bracket body frame structure, and the cover plate 1 can be opened or closed by sliding from the occlusal gingiva direction of the bracket body frame structure. When the archwire 3 needs to be placed, the buccal surface of the canal is opened by sliding the cover plate 1, after which the archwire 3 is placed in the bracket body frame structure, and the buccal surface of the bracket body frame structure is closed by sliding the cover plate 1.

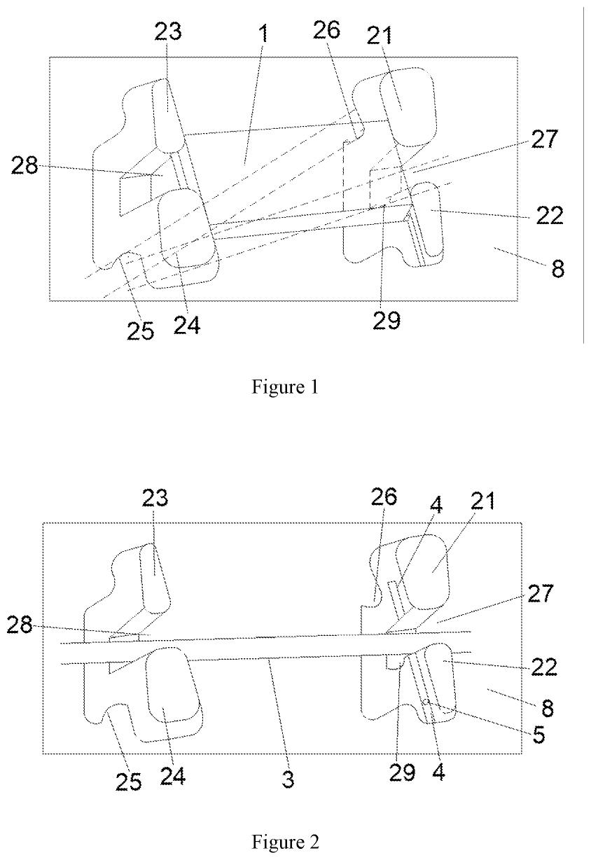

As shown in FIG. 2, the bracket body frame structure includes a first wing 21, a second wing 22, a third wing 23 and a fourth wing 24, a first groove 27 is formed by the first wing 21 and the second wing 22, a second groove 28 is formed by the third wing 23 and the fourth wing 24, and a first tube cavity for accommodating the archwire 3 is formed by axially setting the first groove 27 and the second groove 28. Specifically, the first wing 21 and the third wing 23 are located on the same side of the first tube cavity, and the second wing 22 and the fourth wing 24 are located on the same side of the first tube cavity. The first wing 21 and the fourth wing 24 are each located on the diagonal side of the first tube cavity. A thick round wire or a square archwire 3 can be accommodated in the first tube cavity with the first groove 27 and the second groove 28 having a conventional rectangular groove size of 0.018*0.027 to 0.022*0.028 inches.

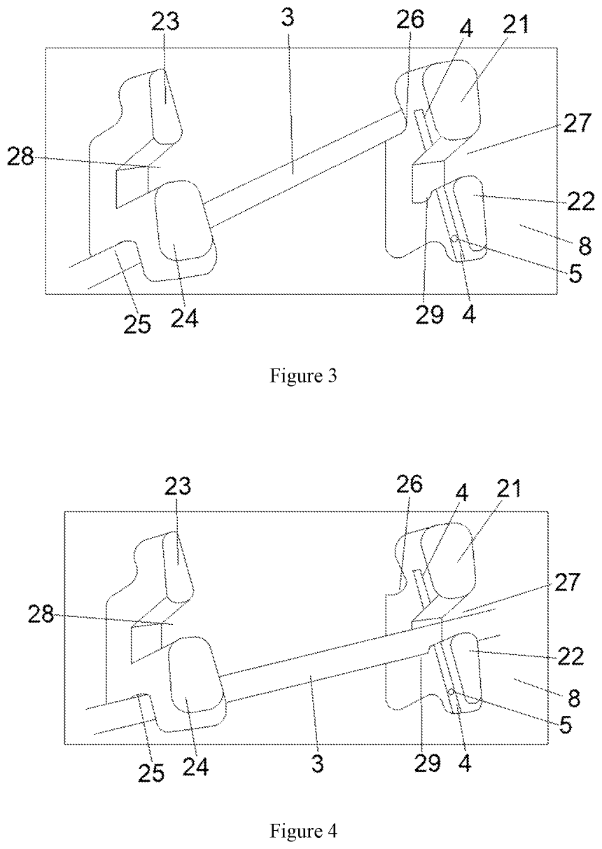

As shown in FIGS. 3 and 4, a first limiting structure is arranged below the first wing 21 and a second limiting structure is arranged below the fourth wing 24, a second channel used for limiting the archwire 3 with tip-back moment is formed by the first limiting structure and the second limiting structure (FIG. 3); a third limiting structure is arranged on the sidewall of the first groove 27 adjacent to the second wing 22, a third channel for limiting the archwire with tip-back moment on the tooth is formed by the third limiting structure and the second limiting structure (FIG. 4). Specifically, by forming the limiting structures under each of the three wings, the first limiting structure and the second limiting structure can be used to limit the archwire 3 with tip-back moment at a larger angle (as shown in FIG. 3), and the third limiting structure and the second limiting structure can be used to limit the archwire 3 with tip-back moment on the molar at a smaller angle (as shown in FIG. 4). It should be understood that the second and third channels are not perforated solid tube cavities, but only provide two-point limitation of the archwire 3 by the two limiting structures, thus allowing the archwire 3 to provide a tip-back moment to the molar when passing through. The design of the limiting structures and corresponding channels allows for unobstructed passage of nickel-titanium round wires up to 0.018 inch in diameter, which enter by the first limiting structure or the third limiting structure and exit through the second limiting structure.

It should be understood that in the field of orthodontics, the inclination of the long axis of clinical crowns is negative when it inclines distally and positive when it inclines mesially, so that when the archwire 3 passes through the limiting structure, a tip-back moment on molars can be generated, and both the limiting structure and the first tube cavity in the following examples enable the archwire 3 to generate a distal-tipping moment on the anchorage molars.

In addition, the first wing 21 can be constructed with a beveled surface at the mesial-edge so that the archwire 3 can be easily inserted into the corresponding channel in the anterior superior to posterior inferior direction.

The present invention provides a buccal tube that, on the basis that the occlusogingival diameter of the conventional double-winged ligature type buccal tube is not increased, three tubes capable of generating three different tip-back moments for the molar are formed by changing the morphology and structure of the four wings, the three tubes includes a first tube cavity used for accommodating the thick round wire or square archwire 3; and two other limiting channels used for accommodating the thin round wire are formed by arranging limiting structures underneath the wings, so as to meet the requirements of different angles of archwires for different orthodontic treatment stages; by providing different tip-back moments for the archwire 3 through the limiting structures, the problem that the archwire 3 cannot be inserted into the buccal tube after the distal end of the archwire being bent is solved by the sliding cover plate design, and the ligature operation of the double-winged ligature type buccal tube is avoided.

In one of the examples of the present invention, the first limiting structure is a first circular groove structure 26 located on the outer wall below the first wing 21; the second limiting structure is a second circular groove structure 25 located on the outer wall below the fourth wing 24. The archwire 3 is limited by the two circular groove structures, thus providing a large angle of distal-tipping moment.

In one example of the present invention, the third limiting structure is a third circular groove structure 29 opened on the inner sidewall of the first groove 27 adjacent to the second wing 22. Specifically, the archwire 3 can be inclined passing the third limiting structure from the mesial opening of the first groove 27 and finally penetrate through the second limiting structure, thus forming a smaller angle of distal tipping. In this example, since the third channel is formed by the second limiting structure and the third limiting structure, the third channel provides a smaller angle of a backward tilting moment compared to the second channel.

In one example of the present invention, the width of the fourth wing 24 is greater than or equal to the width of the third wing 23, and the width of the first wing 21 is greater than or equal to the width of the second wing 22. In this example, by adding or cutting the four wings, the width of the first wing 21 and the fourth wing 24 is wider and the width of the second wing 22 and the third wing 23 is narrower, which in turn makes the projection of the outer contour of the four wings and the contour of the cover plate on the base plate 8 change from a conventional rectangular arrangement to a parallelogram arrangement, so that it is possible to adjust the posterior tilting pipeline without changing the size of the buccal tube in the occlusogingival direction to achieve the design goal of the distal-tipping angle of the molar.

In one example of the present invention, the connecting line between the first limiting structure and the second limiting structure is at an included angle of −30° to −60° in a mesiodistal direction, the connecting line between the second limiting structure and the third limiting structure is at an included angle of −20° to −30° in a mesiodistal direction, and the connecting line between the first groove 27 and the second groove 28 is at an included angle of −2° to −10° in a mesiodistal direction. In this example, the first tube cavity can form a distal-tipping moment of −2°˜−10° for the square archwire 3 or thick round wire that passes through it, where there are differences in the angle settings for the upper and lower jaws, with the backward tilting angle of −4°˜−10° for the upper jaw and −2°˜−6° for the lower jaw; by inserting the archwire 3 into the corresponding limiting structure, it is possible to form a backward tipping moment of −20°˜−60° for the fine round wire.

In one of the examples of the present invention, the connecting line between the first limiting structure and the second limiting structure is at an included angle of −5° to −20° in the buccolingual direction, the connecting line between the second limiting structure and the third limiting structure is at an included angle of 0° to −15° in the buccolingual direction, and the connecting line between the first groove 27 and the second groove 28 is at an included angle of 0° to −10° in the buccolingual direction. In this example, the three limiting structures are adjusted at different distances from the base plate 8, thus controlling the archwire 3 in the buccolingual direction to form a torsional moment of −5° to −20°, and the two grooves are adjusted at different distances from the base plate 8, thus controlling the archwire 3 in the buccolingual direction to form a torsional moment of 0° to −10°.

It should be understood that the above angles of the archwire 3 in a mesiodistal direction or buccolingual direction can be set according to the actual orthodontic situation.

In one of the examples of the present invention, the outer profile of the cover plate 1 is parallelogram, a step-type structure 6 is provided on the cover plate 1, and a track 4 is provided on the walls of the first wing 21, the second wing 22, the third wing 23 and the fourth wing 24, which is adapted to the step-type structure 6, and the cover plate 1 is slidably arranged on the bracket body frame structure by the cooperation of the step-type structure 6 and the track 4. In this example, the outer profile shape of the cover 1 is consistent with the projected shape of the track 4 on the base plate 8, both are parallelograms, and the extension direction of the track 4 is consistent with the parallelogram arrangement formed by adding or cutting to the four wings in the above example.

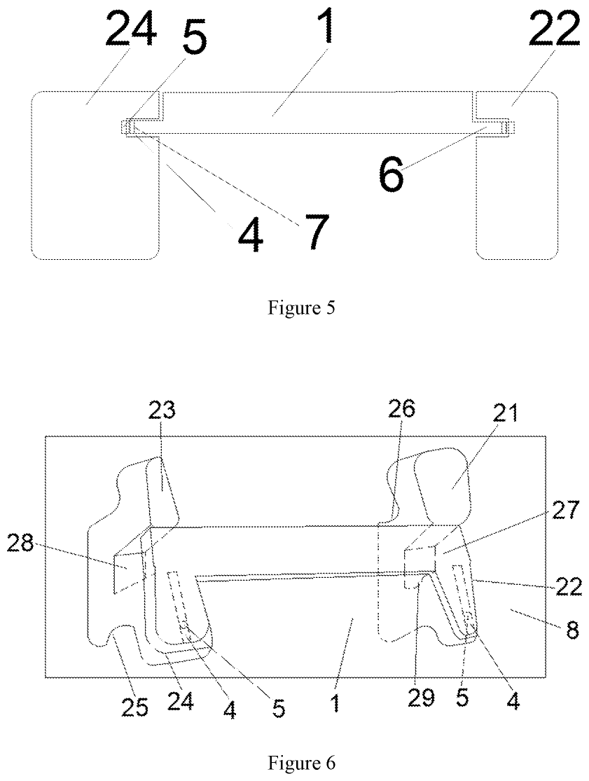

Further, the track 4 can be arranged on the inner sidewall of the wing, and the step-type structure 6 can be arranged on the outer sidewall of the cover plate 1, i.e., the structure shown in FIG. 5; alternatively, the track 4 can also be arranged on the top (i.e., the buccal side) of the wing, i.e., the top of the second wing 22 and the fourth wing 24 are cut, and the track 4 is set on their buccal sides, and the step-type structure 6 is accordingly arranged on the bottom of the cover plate 1 and cooperates with the track, i.e., the structure shown in FIG. 6, and by this way, the length of the cover 1 can be increased accordingly. In the above two examples, the processing position of the track 4 and the step-type structure 6 should both meet the requirement of occlusogingival sliding between the cover plate 1 and the wing, and the track 4 and the step-type structure 6 can be processed in other processing positions, and the present invention is not limited to the above two processing positions.

In one example of the present invention, as shown in FIGS. 5 and 6, the buccal tube also comprises limiting devices 5, the limiting devices 5 are provided on the inner walls of the second wing 22 and the fourth wing 24, respectively, and a recess 7 is provided on the sidewall of the cover plate 1 that is adapted to the limiting device 5, and the limiting device 5 and the recess 7 can snap together accordingly. Specifically, the limit device 5 can be a limiting column or a limiting spring sheet made of elastic materials or an elastic member capable of driving the limiting device 5 back is arranged at the end of the limiting device 5, so that when the cover plate 1 is moved into place, the limiting device 5 and the recess 7 can correspondingly snap together to provide a certain anti-dislodging force to avoid the cover plate 1 from sliding off by the bracket body frame structure; when the cover plate 1 is pulled, it can be dislodged by the limiting device 5, thus being pulled out by the occlusal or gingival direction of the bracket frame structure.

In one of the examples of the present invention, the four wings may have rounded outer corners all around to increase the comfort of the buccal tube.

Based on the above examples, the present invention provides a buccal tube that, on the basis that the occlusogingival diameter of the traditional double-wing ligature type buccal tube is not increased, a first tube cavity used for accommodating a thick round wire or a square archwire 3 is formed by the four wings, and a second channel and a third channel used for accommodating a fine round wire are formed by the three limiting structures to provide a backward tipping moment for the archwire 3, and the problem that the archwire 3 not being able to insert the buccal tube after bending is solved. In addition, through the angular arrangements of the two ends of the first tube cavity, the second channel and the third channel, anti-torsional moment for the archwire 3 is provided so as to avoid mesio-lingual rotation of the molar; the small size design of the buccal tube is satisfied by the parallelogram design of the cover plate 1 and the track 4, and the anti-slip-off of the cover plate 1 is realized by the limiting device 5.

Finally, it should be noted that the above examples are only used to illustrate the technical solutions of the present invention, and not to limit it; despite the detailed description of the present invention with reference to the foregoing examples, it should be understood by a person skilled in the art: it is still possible to modify the technical solutions recited in the foregoing examples, or to make equivalent substitutions for some of the technical features therein; and these modifications or substitutions do not make the essence of the corresponding technical solution depart from the spirit and scope of the technical solution of the examples of the present invention.

What is claimed is:

1. A self-ligating crossed buccal tube, comprising:
a bracket body frame structure and a cover plate, the cover plate being detachably installed on the bracket body frame structure; wherein,
the bracket body frame structure comprises a first wing, a second wing, a third wing and a fourth wing, a first groove is formed by the first wing and the second wing, a second groove is formed by the third wing and the fourth wing, and a first tube cavity used for accommodating an archwire is formed by axially setting the first groove and the second groove;
a first limiting structure is arranged below the first wing, a second limiting structure is arranged below the fourth wing, and a second channel used for limiting a backward tilting moment generated by the archwire is formed by the first limiting structure and the second limiting structure; and
a third limiting structure is arranged in a side wall of the first groove adjacent to the second wing, a third channel used for limiting the archwire with tip-back moment is formed by the third limiting structure and the second limiting structure.

2. The self-ligating crossed buccal tube according to claim 1, wherein, the first limiting structure is a first circular groove structure located on an outer sidewall below the first wing.

3. The self-ligating crossed buccal tube according to claim 2, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

4. The self-ligating crossed buccal tube according to claim 1, wherein, the second limiting structure is a second circular groove structure located on an outer sidewall below the fourth wing.

5. The self-ligating crossed buccal tube according to claim 4, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

6. The self-ligating crossed buccal tube according to claim 1, wherein, the third limiting structure is a third circular groove structure opened on an inner sidewall of the first groove adjacent to the second wing.

7. The self-ligating crossed buccal tube according to claim 6, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

8. The self-ligating crossed buccal tube according to claim 1, wherein, the fourth wing has a width greater than or equal to the width of the third wing, and the first wing has a width greater than or equal to the width of the second wing.

9. The self-ligating crossed buccal tube according to claim 8, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

10. The self-ligating crossed buccal tube according to claim 1, wherein, a connecting line between the first limiting structure and the second limiting structure is at an included angle of −30° to −60° in a mesiodistal direction, a connecting line between the second limiting structure and the third limiting structure is at an included angle of −20° to −30° in a mesiodistal direction, and a connecting line between the first groove and the second groove is at an included angle of −2° to −10° in a mesiodistal direction.

11. The self-ligating crossed buccal tube according to claim 10, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

12. The self-ligating crossed buccal tube according to claim 1, wherein, a connecting line between the first limiting structure and the second limiting structure is at an included angle of −5° to −20° in a buccolingual direction, a connecting line between the second limiting structure and the third limiting structure is at an included angle of 0° to −15° in the buccolingual direction, and a connecting line between the first groove and the second groove is at an included angle of 0° to −10° in the buccolingual direction.

13. The self-ligating crossed buccal tube according to claim 12, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

14. The self-ligating crossed buccal tube according to claim 1, wherein, the cover plate has an outer profile of parallelogram, and a step-type structure is provided on the cover plate, a track is provided on the bracket body frame structure adapted to the step-type structure, and the cover plate is slidably arranged on the bracket body frame structure by the cooperation of the step-type structure and the track.

15. The self-ligating crossed buccal tube according to claim 14, wherein, further comprising a limiting device, the limiting device being provided on the second wing and the fourth wing, respectively, the cover plate is provided with a recess adapted to the limiting device, and the limiting device being able to snap to the recess accordingly.
